(19) United States
(12) Patent Application Publication
(10) Pub. No.: US 2024/0211399 A1
(43) Pub. Date: Jun. 27, 2024

(54) DISTRIBUTED CACHING POLICY FOR LARGE-SCALE DEEP LEARNING TRAINING DATA PRE-PROCESSING

(71) Applicant: Advanced Micro Devices, Inc., Santa Clara, CA (US)

(72) Inventors: Kishore Punniyamurthy, Austin, TX (US); Khaled Hamidouche, Austin, TX (US); Brandon Keith Potter, Austin, TX (US)

(73) Assignee: Advanced Micro Devices, Inc., Santa Clara, CA (US)

(21) Appl. No.: 18/089,480

(22) Filed: Dec. 27, 2022

(51) Int. Cl. G06F 12/0813; G06N 20/00

(52) U.S. Cl. CPC G06F 12/0813; G06N 20/00

(57) ABSTRACT

A distributed cache network used for machine learning is provided which comprises a network fabric having file systems which store data and a plurality of processing devices, each comprising cache memory and a processor configured to execute a training of a machine learning model and selectively cache portions of the data based on a frequency with which the data is accessed by the processor. Each processing device stores metadata identifying portions of data which are cached in the cache memory and other portions of the data which are cached in other processing devices of the network. When requested data is not cached in another processing device, the portion of requested data is accessed from a network file system via a client to server channel and is accessed from another processing device via a client to client channel when the requested data is cached in the other processing device.

### BACKGROUND

Machine learning (e.g., deep learning) is widely used in a variety of technologies (e.g., image classification) to make predictions or decisions to perform a particular task (e.g., whether an image includes a certain object). Machine learning operations typically include multiple layers. At each layer, a filter is applied to the previous layer, and the results of each layer are known as activations or feature maps. The first and last layers in a network are known as the input and output layers, respectively, and the layers in between the first and last layers are known as hidden layers.

Machine learning models are trained in order to make predictions or decisions to perform a particular task (e.g., whether an image includes a certain object). During training, a model is exposed to different data. At each layer, the model makes predictions and receives feedback regarding the accuracy of its predictions.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a diagram illustrating an example distributed cache network in which features of the present disclosure can be implemented;

FIG. 4 is a flow diagram illustrating an example method of accessing data in a distributed cache network according to features of the disclosure;

FIG. 5A illustrates an example counting bloom filter at a first stage of implementation;

FIG. 5B illustrates an example counting bloom filter at a second stage of implementation;

FIG. 5C illustrates an example counting bloom filter at a first stage of implementation; and

FIG. 5D illustrates an example counting bloom filter at a second stage of implementation;

### DETAILED DESCRIPTION

The terms activations and feature maps are used interchangeably in the present disclosure. Machine learning networks are used to predict results for different types of technology applications. For simplified explanation purposes, examples described herein include machine learning networks for image analysis.

The activations of a machine learning model are written to and read from memory for each layer, or a plurality of layers, depending on the particular application. The outputs of each layer are, for example, four dimensional (4D) activations tensors which include an image set that is broken into N batches of feature maps (i.e., channels) C each representing the image and each having a size defined by a height (H) and width (W). The activations tensors are subject to an operation (e.g., convolution kernel, pooling operation), which results in channel data for the next layer.

Deep learning models use significant memory bandwidth, which can lead to performance bottlenecks and increased power consumption. The amount of memory used to store the activation tensor data at different layers of machine learning neural networks is significantly large such that the activation tensor data cannot be saved in on-chip memory. Accordingly, storing the activation tensor data includes transfer of the data to and from off-chip memory.

Extract, transform and load (ETL) is a data ingestion process that combines data from multiple data sources into a centralized database (e.g., file system). Training of a machine learning model often results in bottlenecking of the data storage and ingestion (DSI) pipeline (e.g., data pre-processing) performing the ETLs. The training typically result in large over reads of bytes from storage because the training reads entire rows of data from an input dataset, but uses only a small set of features from each row of data.

Conventional techniques have attempted to reduce the burden on the filesystem by using distributed network caches in which each different network device executing a separate training of a machine learning model shares (distributes) its cache with other network devices. Distributed network caching allows the DSI pipeline to exploit a higher bandwidth (e.g., a network bandwidth in addition to the file system bandwidth) for caching data. However, naive least recently used (LRU) caching policies typically result in thrashing (e.g., multiple main memory locations competing for the same cache lines, due to eviction of useful data, resulting in excessive cache misses), which significantly diminishes the benefits of the caching. In addition, conventional caching techniques (e.g., LRU caching policy) fail to cater to these unique data-reuse patterns used during machine learning jobs.

Features of the present disclosure provide devices and methods which implement an efficient cache allocation policy for a distributed cache network by selectively caching data (e.g., data of input features or activations) that is reused across different machine learning training jobs (i.e., popular data item) while avoiding caching of data that is not reused. Accordingly, the cache allocation policy maintains the increased bandwidth benefit afforded by distributed network caching while avoiding the negative effects of cache thrashing regardless of the replacement policy.

Data that is selected for caching is determined based on frequency with which the data is reused (i.e., accessed). For example, a data item (i.e., portion of a dataset) is selected to be cached in response to a number of accesses of the data (e.g., potion of data of a dataset, such as rows or columns of data) being equal to or greater than a threshold number of accesses (e.g., a number of accesses over a predetermined time period or a number of clock cycles). The threshold number of accesses is, for example, a static threshold determined prior to runtime. Additionally, or alternatively, the threshold number of accesses is dynamically determined (e.g., tuned or set) at runtime based on different factors, such as for example a percentage of concurrently running training jobs accessing a data item. For example, a data item is selectively cached in response to being accessed equal to or greater than 5% of concurrently running training jobs (i.e., threshold=0.05×the number of training jobs).

For large datasets in which tracking thresholds accesses can incur significant overhead, a counting bloom filter-based thresholding is used to limit the overhead.

When data requested by a processing device on the network is identified as cached in another processing device, the data is retrieved from the cache of the other processing device and sent to the requesting processing device via client to client channels of the network instead of via client to server channels. Accordingly the bandwidth along the more frequently used client to server channels is reduced, resulting in a better overall performance.

A distributed cache network used for machine learning is provided which comprises a network fabric comprising a plurality of file systems configured to store data and a plurality of processing devices, each processing device comprising cache memory and a processor. The processor is configured to execute a training of a machine learning model using the data and selectively cache portions of the data based on a frequency with which the data is accessed by the processor.

A processing device of a distributed cache network used for machine learning is provided which comprises cache memory and a processor. The processor is configured to execute a training of a machine learning model using data and selectively cache portions of the data based on a frequency with which the portions of the data are accessed by the processing device.

A method of accessing data in a distributed cache network is provided which comprises executing, by a processor of one of a plurality of processing devices of the distributed cache network, a training of a machine learning model using the data, selectively caching portions of the data in cache memory based on a frequency with which the data is accessed by the processor and for a portion of requested data to execute the training of the machine learning model, in response to determining that the portion of requested data is not cached in another processing device of the distributed cache network, accessing the portion of requested data from a network file system via a client to server channel and in response to determining that the portion of requested data is cached in another processing device via the second metadata, accessing the portion of requested data from the other processing device via a client to client channel.

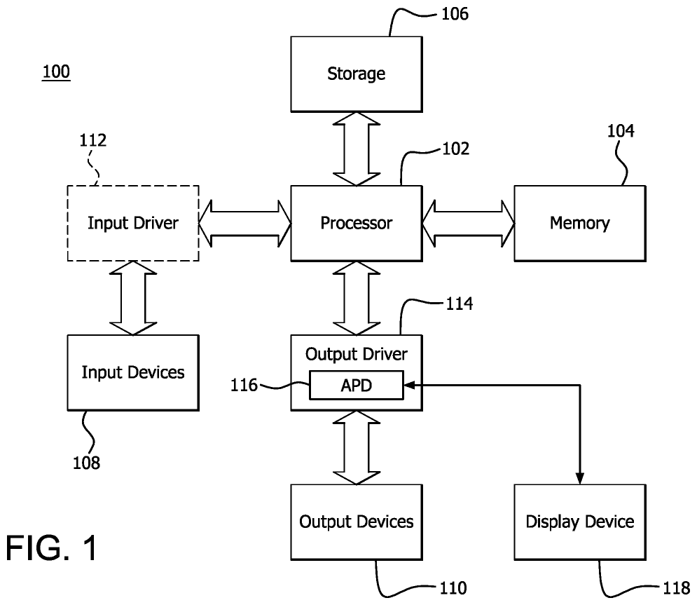

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

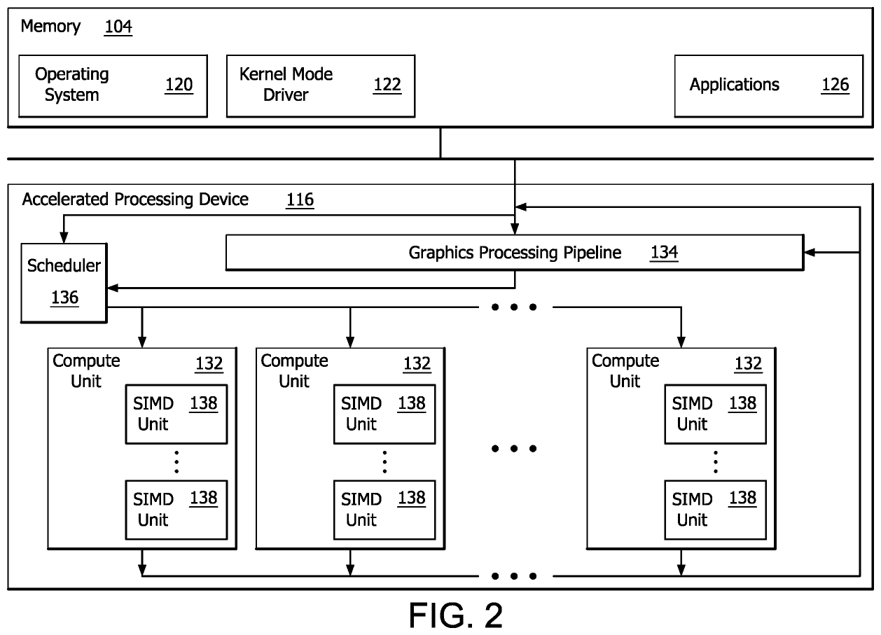

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The APD 116 is configured to execute machine learning models, including deep learning models. The APD 116 is configured to store activation tensor data at different layers of machine learning neural networks. The APD 116 is configured to perform, at each layer, operations (e.g., convolution kernel, pooling operation) to input data (e.g., image, activations tensors) of a previous layer and apply filters to the input data to provide channel data for the next layer.

As described above, the amount of memory used to store the activation tensor data at different layers of machine learning neural networks is significantly large such that the activation tensor data cannot be saved in on-chip memory (e.g., memory at the APD 116). Accordingly, storing the activation tensor data includes transfer of the data between the APD 116 and off-chip memory (e.g., memory 104) via a link (e.g., a bus). The APD 116 is configured to compress the data to be transferred to off-chip memory.

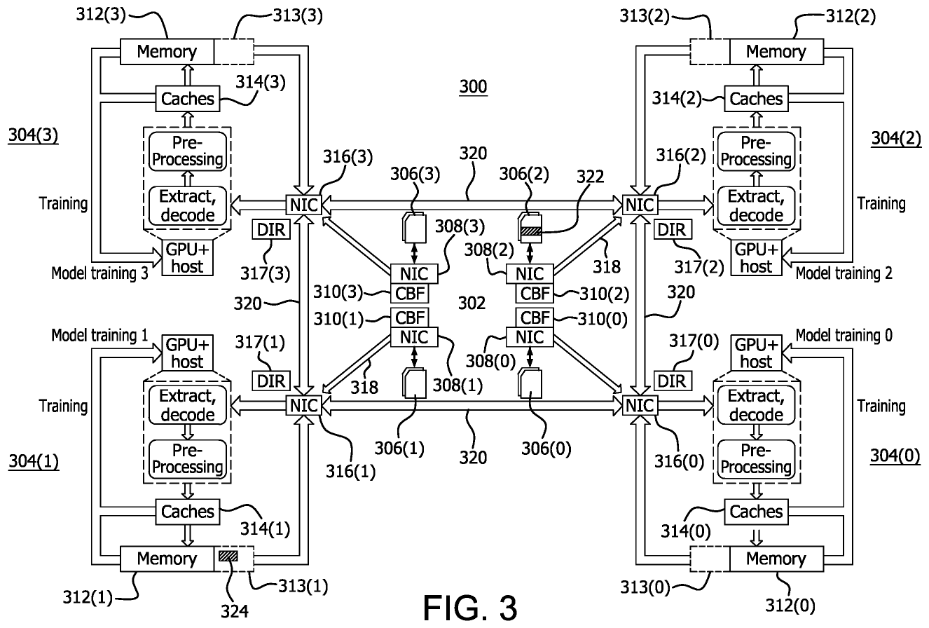

FIG. 3 is a diagram illustrating an example distributed cache network in which features of the present disclosure can be implemented. As shown in FIG. 3, the system 300 includes network fabric 302 and processing devices 304(0), 304(1), 304(2) and 304(3) (collectively processing devices 304). The number of processing devices (e.g., network nodes) shown in FIG. 3 is merely an example. Features of the present disclosure can be implemented for any number of processing devices.

The network fabric 302 includes file systems 306(0), 306(1), 306(2) and 306(3) (collectively file systems 306), network interface hardware circuitry, such as server network interface controllers (NICs) and 308(0), 308(1), 308(2) and 308(3) (collectively server NICs 308). Each file system 306 is accessible (i.e., distributive) by any of the processing devices 304. The network fabric 302 also includes counting bloom filters 310(0), 310(1), 310(2) and 310(3) and (collectively counting bloom filters 310).

Each processing device 304, is for example, a processor such as a CPU, a GPU, an APD (e.g., APD 116) or a field programmable gate array (FPGA). Each processing device 304 includes a corresponding memory 312(0), 312(1), 312(2) and 312(3)(collectively client memory 312), each of which comprises distributed cache portion 313(0), 313(1), 313(2), 313(3) and (collectively distributed cache memory 313) of memory 312(1), 312(2), 312(3) and 31(4) (collectively distributed cache memory 313). Each processing device 304 also includes other portions cache memory 314(1), 314(2), 314(3) and 314(4) (collectively client cache memory 314), and client network interface hardware circuitry, such as NIC 316(1), 316(2), 316(3) and 316(4) (collectively client NICs 316). Each processing device 304 is in communication with a corresponding file system 306 for accessing data from a corresponding file system via a client to server channel 318. Each processing device 304 is also in communication with other processing devices 304 for accessing data from cache memory 314 of the other processing devices 304.

Each client NIC 316 includes a corresponding directory (DIR) 317 (i.e., metadata storage) which stores metadata identifying which portions of data (data items) are cached and in which distributed cache memory (e.g., 313(0), 313(1), 313(2) and 313(3)) the data items are stored.

As shown at block 402, the method 400 includes requesting, by a processing device, access to data in a network file system. For example, processing device 304(2) requests access to a portion of data (i.e., data item).

At block 404, the method 500 includes determining whether or not the requested data is cached in a processing device. Cached data is identified via metadata identifying that the data is cached and in which cache the data is stored. For example, in response to processing device 304(2) requesting access to a portion of data, NIC 316(2) checks its DIR 317(2) (i.e., metadata storage) to determine if the requested data is cached in any one of the processing devices 304.

In response to determining that requested data is not cached in a processing device (No decision), the data is retrieved from the network file system at block 406 and the data is sent to the requesting processing device via a client to server channel, as shown at block 408. For example, in response to determining that the data (e.g., data item 322) requested by processing device 304(2) is not cached in one of the processing devices 304 (No decision), the data (e.g., data item 322 in network file system 306(2)) is retrieved from network file system 306 and the requested data is sent to processing device 304(2)) via the corresponding client to server channel 318. The data item 322 is merely shown in network file system 306(2) as an example. Data items can be retrieved from any of the network file systems 306 for any processing device 304.

In addition, in response to determining that requested data is not cached, the requested data is selectively cached and metadata is stored for data selected to be cached, as shown at block 407. Although block 407 is show as occurring in parallel with block 408, block 407 can also occur prior to block 408.

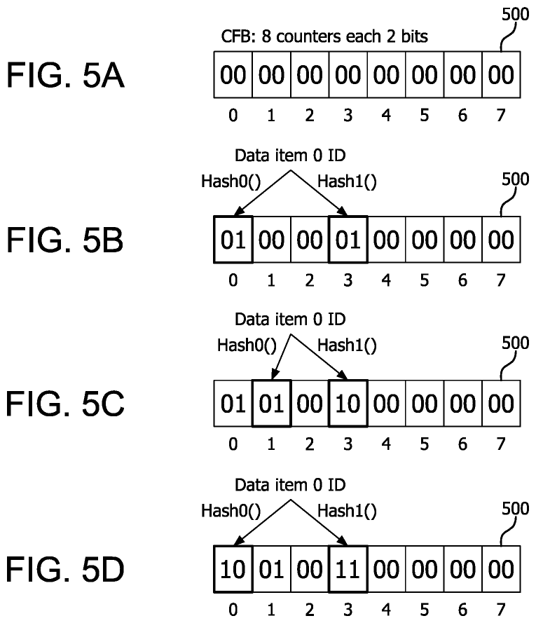

For example, a determination is made as to whether to cache the data requested by processing device 304(2) based on a frequency with which the requested data is accessed. As shown at block 405, the method 400 includes selectively caching data based on frequency with which the data is accessed and storing metadata for the cached data. The requested data item is, for example, selected to be cached in response to a number of accesses of the data (e.g., potion of data of a dataset, such as rows or columns of data) being equal to or greater than a threshold number of accesses (e.g., a number of accesses over a predetermined time period or a number of clock cycles). The threshold number of accesses is, for example, a static threshold determined prior to runtime. Additionally, or alternatively, the threshold number of accesses is dynamically determined (e.g., tuned or set) at runtime based on different factors, such as for example a percentage of concurrently running training jobs accessing a data item. For example, a data item is selectively cached in response to being accessed equal to or greater than 5% of concurrently running training jobs (i.e., threshold=0.05×the number of training jobs). The threshold number of accesses can also be tracked using a counting bloom filter which is described in more detail below with regard to FIG. 5.

The metadata for the cached data (i.e., the metadata indicating the data is cached and in which distributed cache 313 is stored) is sent to and stored in a DIR 317 of each processing device 304. For example, in response to a data item being selectively cached in distributed cache memory 313(1), the metadata indicating that the data item is cached in distributed cache memory 313(1) is stored in DIR 317(1) and sent to the other processing devices, via client to client channels 320, and stored in the DIRs 317(0) 317(2) and 317(3) of the other processing devices 304(0), 304(2) and 304(3). In addition, a corresponding directory (DIR) 317 (i.e., metadata storage) which stores metadata identifying which portions of data (data items) are cached and in which distributed cache memory (e.g., 313(0), 313(1), 313(2) and 313(3)) the data items are stored.

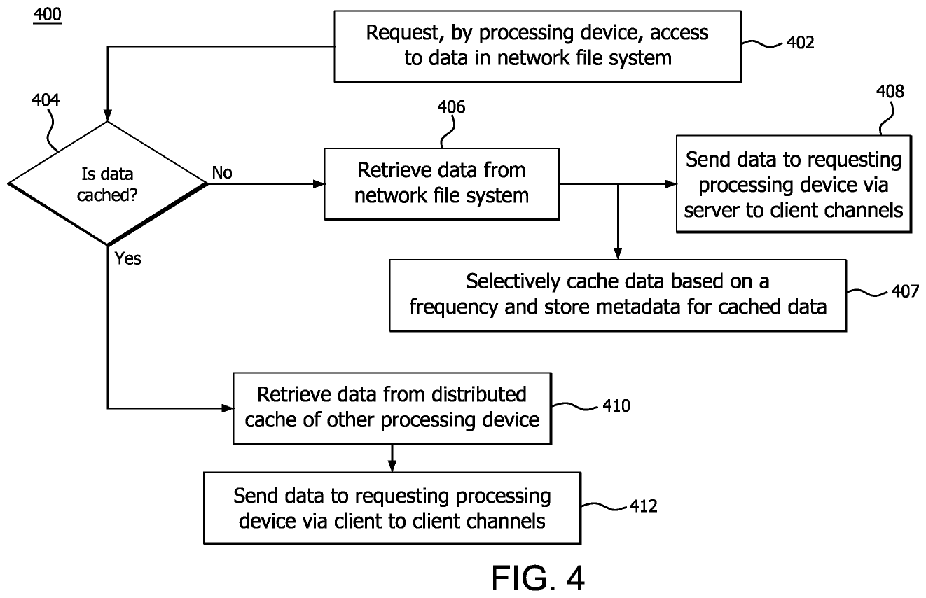

However, in response to determining that the requested data is cached in one of the other processing devices 304 (Yes decision), the method proceeds to block 410 and the data is retrieved from a cache (e.g., distributed cache 313) of one of the processing devices 304. For example, in response to NIC 316(2) determining, via the metadata in its DIR 317(2), that the requested data is cached in distributed cache 313(1) of processing device 304(1), the data is retrieved from distributed cache 313(1) (or alternatively cache 314(1)) of processing device 304(1) at block 410. The data retrieved from distributed cache 313(1) of processing device 304(1) is sent to the requesting processing device (304(2) via client to client channels 320 of the network at block 312, as shown at block 412. For example, the requested data (e.g., data item 324) retrieved from distributed cache 313(1) is sent to processing device 304(2) via client to client channels 320. If the requested data is cached in the same processing device, the cached data is simple retrieved from its own cache (which is not shown in FIG. 4).

Because the data is sent via client to client channels 320, bypassing the client to server channels 318, the bandwidth along the more frequently used client to server channels 318 between the processing devices 304 and the server NICs 308 and file systems 306 is reduced, resulting in a better overall performance.

As described above, data that is selected for caching is determined based on frequency with which the data is reused (i.e., accessed). For example, a data item (i.e., portion of a dataset) is selected to be cached in response to a number of accesses of the data (e.g., potion of data of a dataset, such as rows or columns of data) being equal to or greater than a threshold number of accesses (e.g., a number of accesses over a predetermined time period or a number of clock cycles). The threshold number of accesses is, for example, a static threshold determined prior to runtime. Additionally, or alternatively, the threshold number of accesses is dynamically determined (e.g., tuned or set) at runtime based on different factors, such as for example a percentage of concurrently running training jobs accessing a data item. For example, a data item is selectively cached in response to being accessed equal to or greater than 5% of concurrently running training jobs (i.e., threshold=0.05×the number of training jobs).

For large datasets in which tracking thresholds accesses can incur significant overhead, a counting bloom filter-based thresholding is used to limit the overhead (at the cost of a tolerable number of false positives). A counting bloom filter includes m counters, k different hash functions, each of which maps (i.e., hashes) a set of input elements to one of the m counters. Each counter is a saturating counter with width p bits, where p is determined such that 2p is greater than or equal to a threshold. The overhead incurred is, for example, calculated as m*p bits.

FIGS. 5A-5D illustrate an example counting bloom filter 500 at different stages of implementation according to features of the present disclosure. That is, FIG. 5A illustrates the counting bloom filter 500 at a first stage of implementation. The counting bloom filter 500, is for example, one of the counting bloom filters 310(1), 310(2), 310(3) and 310(4) shown in FIG. 3.

As shown at FIG. 5A, the counting bloom filter 500 includes 8 2-bit wide counters, each of which are set to 0. The number of counters and counter size (i.e., number of bits) of each counter of counting bloom filter 500 is merely an example. Features of the present disclosure can be implemented with a number of counters different that the number of counters in counting bloom filter 500 and a counter size different than the counter size of counting bloom filter 500. The example shown in FIGS. 5A-5B also use 2 hash functions. However, features of the present disclosure can be implemented using a different number of hash functions.

Data item 0 and data item 1 are accessed, at FIGS. 5B and 5C, and are subsequently tracked by the counting bloom filter 500. For example, as shown at FIG. 5B, data item 0 is accessed and its corresponding counter (counter 0) is incremented from 00 to 01. In addition, the identifier (ID) of data item 0 is hashed and counter 3 (i.e., hash counter) is incremented from 00 to 01. As shown at FIG. 5C, data item 1 is accessed and its corresponding counter (counter 1) is incremented from 00 to 01. In addition, the identifier (ID) of data item 1 is hashed and counter 3 is incremented from 01 to 10 (i.e., incremented from a count of 1 to a count of 2).

Data item 0 is accessed a second time, which is tracked by the counting bloom filter 500 as shown in FIG. 5D. That is, in response to data item 0 being accessed a second time, its corresponding counter (counter 0) is incremented from 01 to 10. In addition, the identifier (ID) of data item 0 is again hashed and counter 3 (i.e., hash counter) is incremented from 10 to 11.

To determine if a particular data item has been accessed a threshold number (e.g., 2) of times, the ID of the data item is hashed and the values of the counters are checked. If any counter is less than 2, then the data item is determined to not have been accessed the threshold number of times. However, if each of the counter values are equal to or greater than 2, then it is determined that the data item has been accessed the threshold number of times. For example, in the example shown in FIGS. 5A-5D, data item 0 is determined as being accessed 2 times (counter 0: 10, counter 3: 11), but data item 1 is determined as not being accessed 2 times (counter 1: 01, counter 3: 11).

Features of the present disclosure can be implemented with counters set to a value other than zero, and counts can be implemented by incrementing or decrementing the counters.

Because counters will eventually saturate and become ineffective, when decrementing the counters, the counters are decremented corresponding to the data items which are evicted from the cache instead of resetting counters and losing all the previous tracking information.

The data items are inserted into cache if the counting bloom filter counter values are above a threshold. When the data items are evicted, their corresponding counters are decremented by threshold amount.

The distributed caches described above are configured to use a write-evict policy. That is, if the data is modified, the cached copies are invalidated, and the updates are written to the file.

Features of the present disclosure also include caching pre-processed data of smaller sizes, which provides a benefit of skipping computations at re-use. However, features of the present disclosure also include caching un-processed data when different sets of pre-processing is used for different training jobs.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, and SIMD units 138 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A distributed cache network used for machine learning, the network comprising:
a network fabric comprising a plurality of file systems configured to store data;
a plurality of processing devices, each processing device comprising cache memory and a processor, the processor configured to:
execute a training of a machine learning model using the data; and
selectively cache portions of the data based on a frequency with which the data is accessed by the processor.

2. The distributed cache network of claim 1, wherein a portion of the data is selectively cached by the processor in response to a number of accesses of the portion of data being equal to or greater than a threshold number of accesses.

3. The distributed cache network of claim 2, wherein the threshold number of accesses is a static threshold determined prior to runtime.

4. The distributed cache network of claim 2, wherein the threshold number of accesses is dynamically determined at runtime.

5. The distributed cache network of claim 2, further comprising metadata storage configured to store metadata identifying in which cache memory, of the plurality of processing devices, each portion of data is cached.

6. The distributed cache network of claim 1, wherein the network fabric comprises counting bloom filters, each dedicated to corresponding processing device and configured to track a number of accesses of each of a plurality of different portions of the data by the corresponding processing device.

7. The distributed cache network of claim 1, wherein
each file system of the network fabric is accessible by each of the processing devices, and
the network further comprises:
client to server channels each configured to provide requested portions of data to a corresponding processing device from one of the file systems; and
client to client channels each configured to provide requested portions of cached data to a processing device requesting the cached data from another processing device while bypassing the network fabric and the client to server channels.

8. A processing device in a distributed cache network used for machine learning, the processing device comprising:
cache memory; and
a processor configured to:
execute a training of a machine learning model using data; and
selectively cache portions of the data based on a frequency with which the portions of the data are accessed by the processing device.

9. The processing device of claim 8, wherein a portion of the data is selectively cached by the processor in response to a number of accesses of the portion of data being equal to or greater than a threshold number of accesses.

10. The processing device of claim 9, wherein the threshold number of accesses is a static threshold determined prior to runtime.

11. The processing device of claim 9, wherein the threshold number of accesses is dynamically determined at runtime.

12. The processing device of claim 9, wherein the threshold number of accesses is dynamically determined based on a percentage of concurrently running training jobs accessing the portion of the data.

13. The processing device of claim 9, further comprising a metadata storage configured to:
store first metadata identifying the portions of the data which are cached in the cache memory of the processing device; and
store second metadata identifying other portions of the data which are cached in other processing devices of the distributed cache network.

14. The processing device of claim 13, wherein the processor is configured to:
provide, to the other processing devices, the metadata identifying the portions of the data which are cached in the cache memory of the processing device; and
for a portion of requested data to execute a training of the machine learning model:
in response to determining that the portion of requested data is not cached in the other processing devices, access the portion of requested data from a network file system via a client to server channel; and
in response to determining that the portion of requested data is cached in another processing device via the second metadata, access the portion of requested data from the other processing device via a client to client channel.

15. A method of accessing data in a distributed cache network, the method comprising:
executing, by a processor of one of a plurality of processing devices of the distributed cache network, a training of a machine learning model using the data;
selectively caching portions of the data in cache memory based on a frequency with which the data is accessed by the processor; and
for a portion of requested data to execute the training of the machine learning model:
in response to determining that the portion of requested data is not cached in another processing device of the distributed cache network, accessing the portion of requested data from a network file system via a client to server channel; and
in response to determining that the portion of requested data is cached in another processing device, accessing the portion of requested data from the other processing device via a client to client channel.

16. The method of claim 15, wherein a portion of the data is selectively cached by the processor in response to a number of accesses of the portion of data being equal to or greater than a threshold number of accesses.

17. The method of claim 16, wherein the threshold number of accesses is a static threshold determined prior to runtime.

18. The method of claim 16, wherein the threshold number of accesses is dynamically determined at runtime.

19. The method of claim 16, wherein the threshold number of accesses is dynamically determined based on a percentage of concurrently running training jobs accessing the portion of the data.

20. The method of claim 15, further comprising:
storing first metadata identifying the portions of the data which are cached in the cache memory; and
storing second metadata identifying other portions of the data which are cached in other processing devices of the distributed cache network.
